(19) United States
(12) Patent Application Publication
(10) Pub. No.: US 2011/0071852 A1
(43) Pub. Date: Mar. 24, 2011

(54) Health Information Management Systems and Methods

(75) Inventor: Ahamadu Sirleaf, Pikesville, MD (US)

(73) Assignee: E-HEALTH PORTFOLIO, INCORPORATED, Minneapolis, MN (US)

(21) Appl. No.: 12/878,424

(22) Filed: Sep. 9, 2010

Related U.S. Application Data
(60) Provisional application No. 61/243,694, filed on Sep. 18, 2009.

(51) Int. Cl. G06Q 50/00; G06Q 10/00

(52) U.S. Cl. 705/3

(57) ABSTRACT

Embodiments provide computerized methods and systems for managing electronic health data. In some cases a health data management system includes at least a local processing module, a zone database module, and a global database module. The local processing module stores a patient health record and generates and transmits a patient data set based on the health record to the zone database module. In some cases the patient data set excludes one or more portions of the patient health record. The zone database module may send the patient data set to one or more additional local processing modules without sending the excluded portion of the patient health record. In some cases the excluded portion includes patient assessment data and the transmitted portion includes patient subjective, objective and/or plan data.

### CROSS-REFERENCES

This application claims the benefit of U.S. Provisional Application No. 61/243,694, filed Sep. 18, 2009, the content of which is hereby incorporated by reference in its entirety.

### BACKGROUND

Health care providers are increasingly maintaining medical records electronically because, at least in part, electronic records are simpler and less expensive to create, maintain and work with as compared to traditional paper records. In fact, traditional paper records are being converted to electronic formats at an accelerated pace.

In response to this electronic revolution, systems have been developed which attempt to protect the privacy of medical information while utilizing the advantages of electronic information technology. These systems typically involve the storing of patient health data in a centralized database and/or using a device, such as a smart card issued to patients, to store personal details and important medical facts (such as blood type, immunization history, and drug prescriptions).

As the prevalence of electronic medical records increases, a need exists for new and more sophisticated modes of storing, searching, and sharing these records.

### SUMMARY

According to one aspect of the invention, a computerized method for managing electronic health data is provided. The method includes receiving a first patient data set from a first local processing module. The first patient data set includes part of an electronic first patient health record stored in a first local database and the first patient health record corresponds to a first patient of a first health care provider. In some cases the first patient data set excludes a first portion of the first patient health record. The method further includes storing the first patient data set in a first zone database using a first system identifier and maintaining a global database that stores the first system identifier and a corresponding first personal identifier corresponding to the first patient.

In some embodiments, the method further includes receiving the first personal identifier from a second local processing module and searching the global database for the first personal identifier and the corresponding first system identifier. The first patient data set is retrieved from the first zone database using the first system identifier, and the first patient data set is sent to the second local processing module without sending the first portion of the first patient health record stored on the first local database. In some embodiments the first patient health record includes subjective data, objective data, assessment data, and plan data that correspond to the first patient. The excluded first portion of the first patient health record may include the assessment data.

According to another aspect of the invention, a computerized health data management system is provided. The system includes a first local processing module adapted to store an electronic first patient health record in a first local database and generate a first patient data set based on the first patient health record. The first patient health record corresponds to a first patient of a first health care provider, and the first patient data set excludes a first portion of the first patient health record. The system also includes a first zone database module adapted to receive the first patient data set from the first local processing module and store the first patient data set in a first zone database using a first system identifier that corresponds to the first patient. In addition, a global database module is provided that is adapted to store the first system identifier and a corresponding first personal identifier in a global database and retrieve the first system identifier using the first personal identifier corresponding to the first patient.

In some embodiments the system also includes a second local processing module adapted to receive the first personal identifier and send the first personal identifier to the first zone database module. The first zone database module is further adapted to receive the first personal identifier from the second local processing module, send the first personal identifier to the global database module, receive the first system identifier from the global database module, retrieve the first patient data set from the first zone database using the first system identifier, and send the first patient data set to the second local processing module without sending the first portion of the first patient health record stored in the first local database.

### BRIEF DESCRIPTION OF THE DRAWINGS

The following drawings are illustrative of particular embodiments of the present invention and therefore do not limit the scope of the invention. The drawings are not to scale (unless so stated) and are intended for use in conjunction with the explanations in the following detailed description. Embodiments of the present invention will hereinafter be described in conjunction with the appended drawings, wherein like numerals denote like elements.

FIG. 1 is a block diagram of a system for managing electronic health data according to an embodiment of the invention.

FIG. 2 is a block diagram of a hardware implementation of the system of FIG. 1 according to an embodiment of the invention.

FIGS. 3A-3D are block diagrams of a health data management system illustrating transfer of health data according to an embodiment of the invention.

FIG. 4 is a partial block diagram of a health data management system illustrating transfer of health data according to an embodiment of the invention.

FIG. 5 is flow diagram illustrating a method for managing electronic health data according to an embodiment of the invention.

FIG. 6 is a block diagram of a local processing module and local databases for managing health data according to an embodiment of the invention.

FIG. 7 is a depiction of a system prompt for biometric data according to an embodiment of the invention.

FIG. 8 is a depiction of a patient registration screen according to an embodiment of the invention.

FIG. 9 is a depiction of a patient vitals screen according to an embodiment of the invention.

FIG. 10 is a depiction of a doctor access screen according to an embodiment of the invention.

FIG. 11 is a block diagram of a health data management system illustrating a global database organization according to an embodiment of the invention.

FIG. 12 is a flow diagram illustrating a method of searching a health data management system database for a personal identifier according to an embodiment of the invention.

### DETAILED DESCRIPTION OF THE PREFERRED EMBODIMENTS

The following detailed description is exemplary in nature and is not intended to limit the scope, applicability, or configuration of the invention in any way. Rather, the following description provides practical illustrations for implementing exemplary embodiments of the present invention. Examples of constructions, materials, dimensions, and manufacturing processes are provided for selected elements, and all other elements employ that which is known to those of skill in the field of the invention. Those skilled in the art will recognize that many of the examples provided have suitable alternatives that can be utilized.

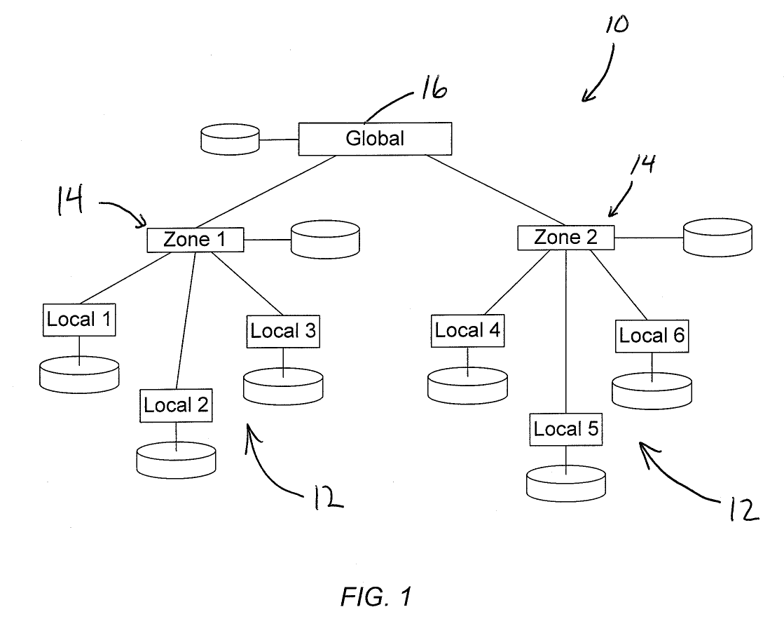

FIG. 1 shows a block diagram of an architecture for an electronic health data management system 10 according to some embodiments of the invention. The system 10 generally provides for the electronic handling and storage of health data for one or more patients receiving care from one or more health care providers. In some embodiments the system 10 includes one or more local processing modules 12 that enable handling and storage of health data for patients at a local level, such as at a patient's local health care provider. In certain embodiments the local processing modules 12 are electronically coupled and communicate with one or more zone database modules 14 that collect and store portions of the health data stored at the local level and also manage data flow between local processing modules 12. The system 10 may further include a global database module 16 coupled and communicating with the one or more zone database modules 14. The global database module 16 manages data flow between zone modules 14 and may also enable storage of data in some embodiments of the invention.

As will be discussed in further detail, embodiments of the health data management system 10 provide a number of uses and advantages in handling and storing electronic patient health data. In certain embodiments the system 10 enables the selective sharing of patient health data at the local level. For example, a patient's health record (e.g., part of and/or including the patient's health data) may be shared between two or more health care providers while excluding portions of the health record. The system 10 may also provide centralized and/or regionalized storage of patient health records at the zone database module 14 level, providing backup of health data and allowing convenient and easy forwarding of patient health records to one or more local level facilities. In some embodiments, one or more portions of a patient health record may not be stored by the zone database module.

In some cases the system 10 may store health data using a patient's personal identifier (e.g., a Social Security number, birth date, biometric information, etc.), while also separately storing the personal identifiers and portions of the health data to provide additional privacy protections. For example, in some embodiments personal identifiers and registration information are stored by the global database module 16, portions of patient health records are stored by the zone database modules 14 without the personal identifiers (e.g., an arbitrary system ID may be used instead), and local processing modules may store a more complete version of patient health records.

In further embodiments, searching for health data is facilitated with location information. For example, a search within a vast database of health data for a specific health record may start within a specific subgroup of health data identified by the location of the requester. Other advantages and uses will become apparent hereinafter.

Embodiments of the health data management system 10, as well as methods of using the system, may be implemented in a number of manners depending upon the particular requirements for a specific implementation. In some cases, the system 10 is provided as a number of software modules configured to operate on various forms of computing hardware. The software modules can be designed and programmed to manage health data as will be further described herein. The modules may communicate over one or more landline and/or wireless networks in order to transfer health data between modules. Of course, elements of the invention, including local processing module(s), zone database module(s) and/or global database module(s), may be implemented in a variety of forms, such as in software, firmware, and/or hardware as those skilled in the are will appreciate. The invention is not limited to any one embodiment and a number of implementations are possible.

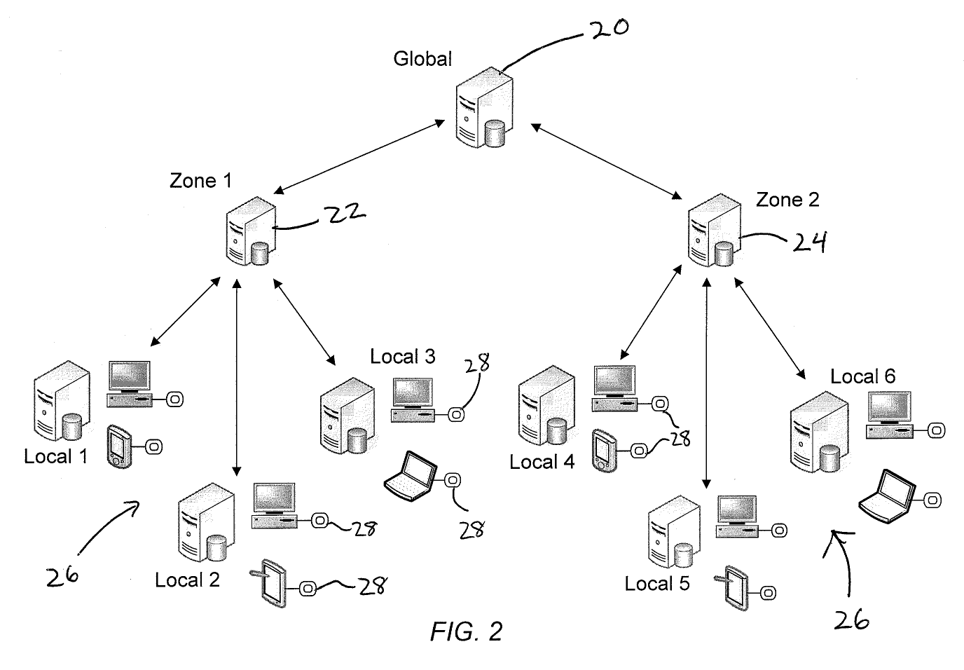

FIG. 2 shows a block diagram of one hardware/software implementation of the electronic health data management system 10 of FIG. 1 according to some embodiments of the invention. In general, the hardware system includes a number of computing systems distributed among multiple locations over a network. For example, the system includes a global computing system 20 capable of providing the global database module 16, a first and a second zone computing systems 22, 24 capable of providing the zone database modules 14, and a number of local computing systems 26 capable of providing the local processing modules 12 of the system 10. The computing systems can take a variety of forms as will be appreciated. As just a few examples, the computing systems may comprise general purpose computers, web servers and/or database servers, laptops, PDAs, and/or tablet PCs. In some embodiments the computing systems may include separate databases coupled with the computers for storing health data, or may rely on integrated storage or database capability.

In some embodiments, one or more of the computing systems (e.g., providing the local processing modules 12) may include one or more input devices that allow a patient or other person to enter a personal identifier into the system 10 to access and manage the patient's health data. As shown in FIG. 2, in some cases a computing system may include a biometric scanning device 28 that receives a biometric marker from the patient to be used as the patient's personal identifier. For example, the scanning device 28 may comprise a fingerprint reader, such as those manufactured and sold by DigitalPersona. Once input, the biometric marker can then be used to directly or indirectly index and access the patient's health data within the system.

The electronic health data management system 10 can be provided in multiple forms depending upon the desired capacity for health data management. For example, the system 10 may be configured to manage health data across different areas for different numbers of health care providers and patients. In some embodiments the system 10 may manage health data across counties, states, countries, and/or even continents. In some embodiments the system 10 may be configured to manage health data for multiple local users (e.g., health care providers) and/or may be configured to manage health data for a single local user. Local processing modules may be adapted to service a wide variety of local users. For example, local system users, i.e., those accessing and utilizing the system at the local processing module level, can include hospitals, clinics, ambulances and other emergency vehicles, pharmacies, schools, refugee camps, and/or personal patient computers among other users.

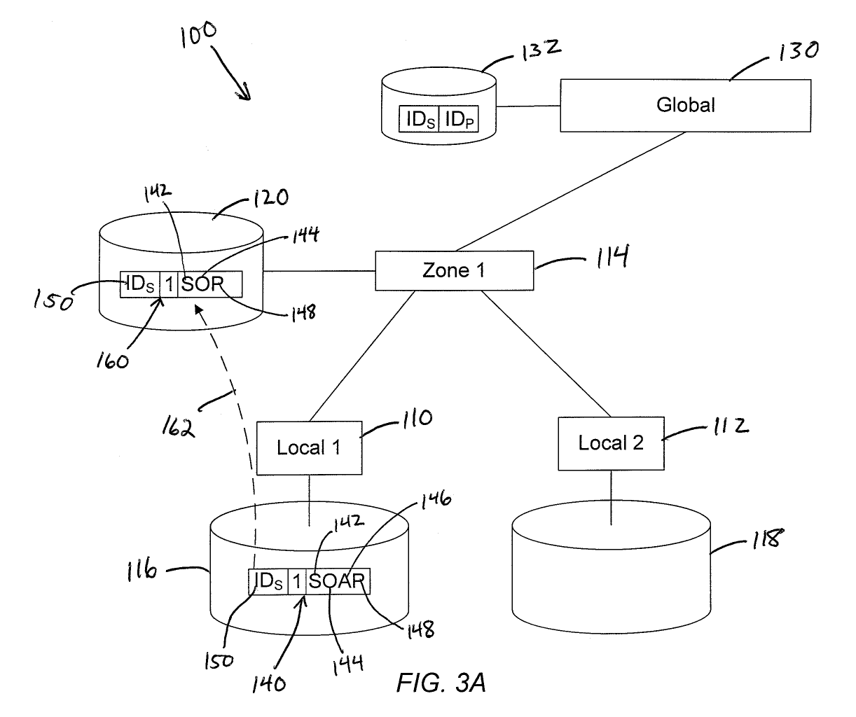

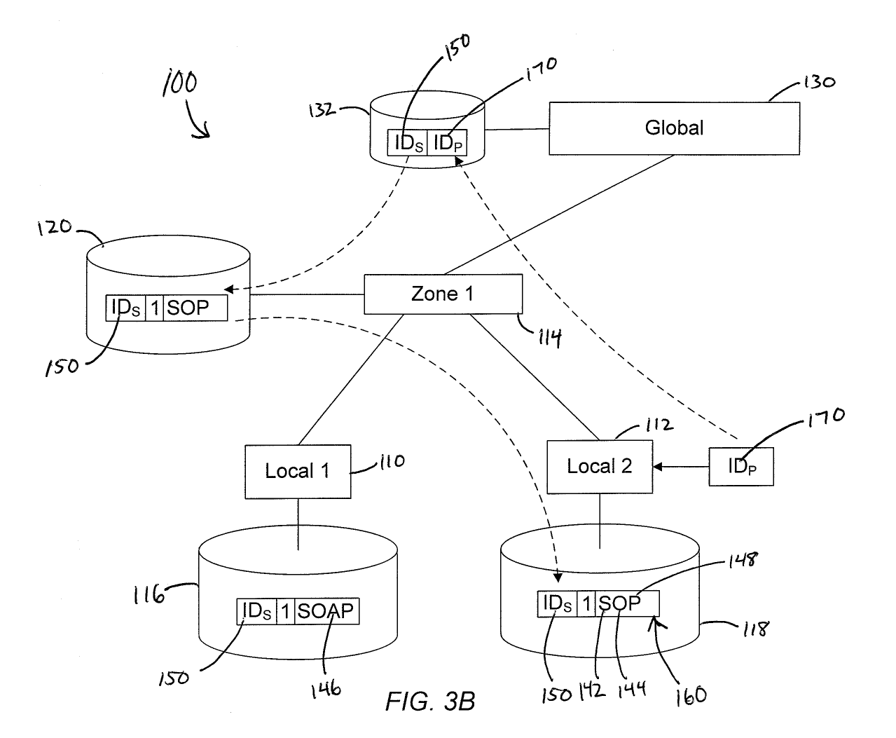

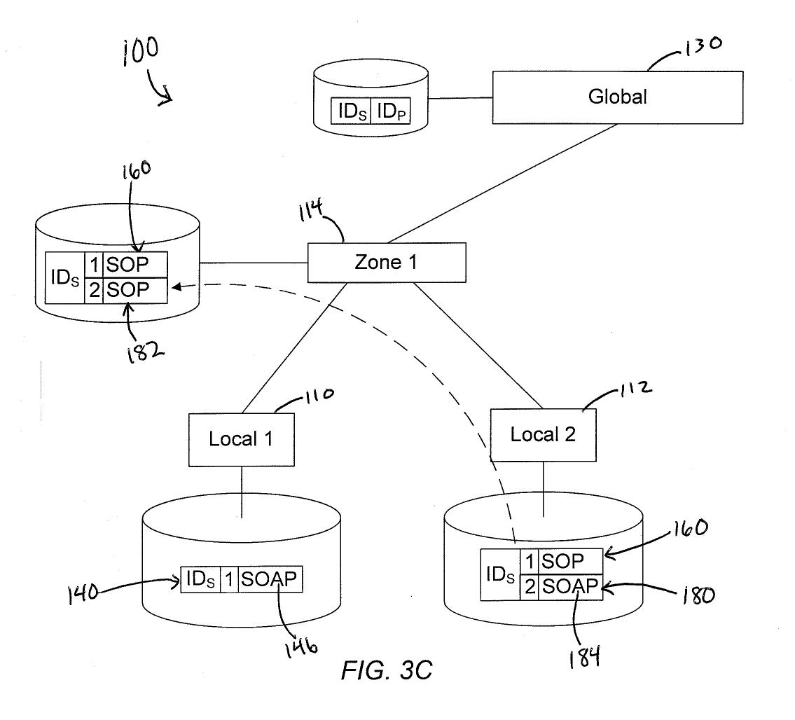

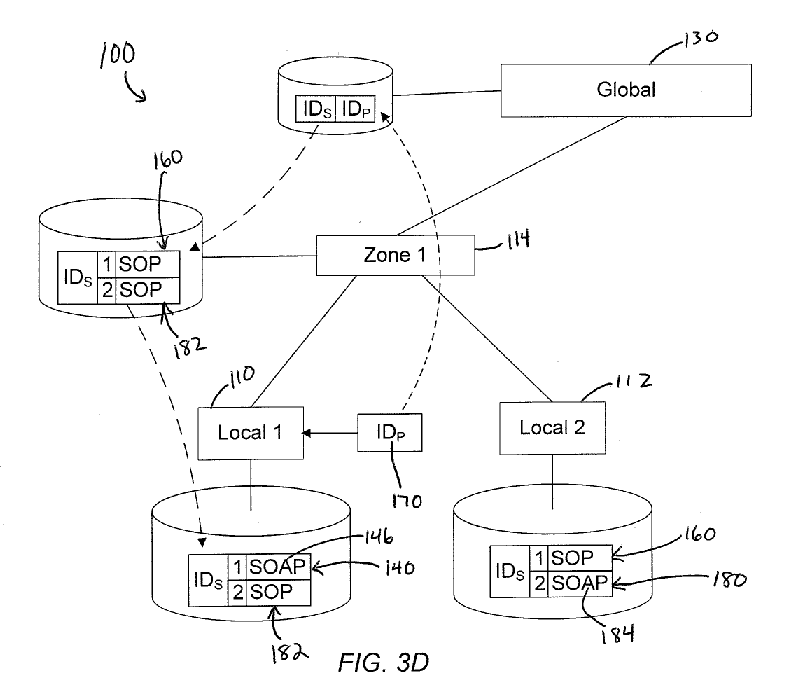

FIGS. 3A-3D show block diagrams of an electronic health data management system 100 and illustrate possible flows of health data through the system 100 according to some embodiments of the invention. The system 100 includes a specific example of a set number of processing modules, though it should be appreciated that the system 100 can be scaled to include more or less processing modules and/or levels of processing. For example, a similar system may include two or more zones and multiple associated local processing modules.

Turning to FIG. 3A, in this embodiment the system 100 includes a first local processing module 110 and a second local processing module 112 electronically coupled and in communication with a first zone database module 114. The first and the second local processing modules 110, 112 are each coupled with and/or incorporate first and second local databases 116, 118, respectively, for storing health data. The first and/or second local processing modules 110, 112 may be associated with a variety of local users. In some embodiments, each of the first and second local processing modules are associated with a health care provider, such as a hospital or clinic, that services a number of patients.

The first zone database module 114 couples the first and the second local processing modules 110, 112 and facilitates the transfer of health data between them, if any. In some embodiments the first zone database module 114 receives health data from one or more of the local processing modules and stores the health data in a first zone database 120. The first zone database 120 can store health data corresponding to multiple patients from multiple local processing modules, and thus provides a convenient and regionalized or centralized location for health data storage and/or backup storage. The first zone database 120 and first zone database module 114 may serve geographical regions of varying size, depending upon the complexity of the system 100 and the need for one or more zones.

In some embodiments, health data is stored in the first zone database 120 using system identifiers. For example, the system identifiers can in some cases provide an anonymous manner of indexing and storing health data without personally identifying the patient associated with the health data. As shown in FIG. 3A, the first zone database module 114 is coupled with a global database module 130, which includes its own global database 132 for storing identification information. For example, in some embodiments the global database 132 stores a catalogue of personal identifiers and their corresponding system identifiers. Thus, the global database and module 132, 130 provide the system 100 with separation of personally identifiable information and associated health data. In the case the first zone database 120 is compromised, health data may be exposed, but without personally identifiable information. In the case the global database 132 is compromised, personal identifiers and corresponding system identifiers may be exposed, but without corresponding health data.

In addition, in some embodiments, the first zone database 120 may not store all health data held locally by the local processing module, but may instead only store portions of the health data stored locally. For example, certain information such as doctor assessments and diagnoses may be excluded from the health data stored in the first zone database 120 to further safeguard certain health data from unauthorized access.

As shown schematically in FIG. 3A, the first local processing module 110 stores an electronic first patient health record 140 on the first local database 116. The first patient health record 140 corresponds to a first patient of a first health care provider. For example, the first patient health record 140 may include all manner of health data generated at the first health care provider for the first patient, including medical test results, nurse observations, patient-reported symptoms, medications prescribed and taken, diagnoses, treatment regimens, and the like. The first patient health record 140 may also include biographical or registration information, personally identifiable information, and other non-health data.

In some embodiments the health data within the first patient health record 140 is sorted into one or more categories to facilitate filtering and transfer of health data. For example, in some certain embodiments, health data within the first patient health record 140 is sorted into one of four broad categories according to the SOAP methodology. In this case, the health data within the record is sorted and categorized as subjective data 142, objective data 144, assessment data 146, and/or plan data 148.

The scope and/or overlap of the SOAP categories may vary somewhat between health care providers. In general, subjective data 142 can be considered to include information reported by the patient, such as reports of the patient's subjective assessment of his or her physical/mental condition. Objective data 144 can generally be considered to include objectively-verifiable health data, such as height, weight, blood pressure, test results, and the like. Assessment data 146 often includes doctors' notes, diagnoses, prognoses and other information reflecting the doctors' thinking and assessment of the patient. Plan data 148 often includes information about medical prescriptions, treatments, suggested therapies, etc. In some embodiments, the health record 140 may be categorized according to the SOAPO methodology, in which the record additionally includes outcome data indicative of the success of the prescribed therapies and/or medications.

In some embodiments the first patient health record 140 is stored within the first local database using a first system identifier 150 corresponding to the first patient. For example, the database may index health records according to corresponding system identifiers, which may include an alphanumeric string representing a specific patient. In certain cases the system identifiers do not include personally identifiable information (e.g., they are random or otherwise arbitrary strings), so that records can be accessed and retrieved without the need for personally identifiable information.

In certain embodiments of the invention, the first local processing module 110 is adapted to generate a first patient data set 160 from the first patient health record 140 and send the first patient data set 160 to the first zone database module 114 for storage in the first zone database 120. The first patient data set 160 includes health data from the first patient health record 140, but preferably does not include all the health data from the record. In some embodiments the first patient data set 160 excludes a first portion of the first patient health record. For example, the first patient data set 160 may exclude the assessment data 146 found in the electronic health record 140. Excluding one or more portions of the health record from the health data set stored in the zone database can further increase security and protect the privacy of patients' health data. In this case, assessment data 146, which can be particularly sensitive, is excluded from the patient data sets stored in the zone database. In the case that the zone database is compromised, the assessment data 146 will not be exposed to unauthorized access.

After generating the first patient data set 160, the first local processing module 110 sends, and the first zone database module 114 receives 162, the first patient data set 160 and stores the data set in the first zone database 120. While FIG. 3A illustrates an example of storage of a single first patient data set 160, it is appreciated that the first zone database 120 in reality may store multiple data sets, corresponding to multiple patients, received from one or more local processing modules. In some embodiments the first patient data set 160 is stored in the first zone database using the first system identifier 150. In some embodiments, the global database stores multiple personal identifiers and multiple corresponding system identifiers.

In some embodiments the first patient data set 160 stored in the first zone database 120 can be retrieved using a first personal identifier 170 corresponding to the first patient. In certain embodiments, the first personal identifier 170 and corresponding first system identifier 150 are stored in the global database 132. Turning to FIG. 3B, in some embodiments a user (e.g., patient, provider, etc.) can input the first personal identifier 170 into the second local processing module 112. For example, a user may key in a numerical identifier, such as a Social Security number or data of birth, into the system. In some embodiments a patient may input a biometric marker or identifier into the system through a biometric scanning device. For example, a patient may access the system through the use of a fingerprint scanner. In certain cases the personal identifier may be stored by the second local processing module such that it can automatically be retrieved when needed.

Once it obtains the first personal identifier 170, the second local processing module 112 transmits the first personal identifier 170 to the first zone database module 114, which relays the identifier to the global database module 130. The global database module 130 searches the global database 132 for the first personal identifier 170 in order to retrieve the corresponding first system identifier 150. Once the first system identifier 150 is retrieved, it is relayed back to the first zone database module 114, which uses it to retrieve the first patient data set 160 from the first zone database 120 and send the first patient data set 160 to the second local processing module, where it is stored in the second local database 118.

As illustrated in FIG. 3B, in some embodiments the first patient data set 160 is sent to the second local processing module 112 without sending the portion of the original first patient health record 140 excluded from the first data set. Excluding portions of the first patient health record when transmitting the health data provides a number of advantages not provided by existing health record management systems. For example, limiting transmission of the health data to only portions of the existing health records can further protect against unauthorized access or use of the excluded health data.

In another example, sharing basic health data between health care providers can facilitate the care provided to a common patient of two or more health care providers. At the same time, in some cases it may be desirable to limit the shared information to protect the privacy of the patient and/or health care providers. In some embodiments subjective data 142, objective data 144, and plan data 148 included in the first patient data set 160 are shared among providers, while the excluded first portion including the assessment data 146 is not shared. Thus, a second physician treating a common patient can have access to the underlying health data and prescriptions of the patient without having access the ultimate conclusions (i.e., assessments) of a first treating physician.

FIGS. 3C and 3D show the system 100 transferring health data from the second local processing module 112 to the first local processing module 110 in much the same manner as shown in FIGS. 3A and 3B. In this example, health data from a second patient health record 180 gathered, generated and/or stored at the location of the second local processing module 112 (e.g., a second health care provider) is sent to the first zone database module 114 and first zone database 120 as a second patient data set 182 while excluding a second portion of the second patient health record 180. In this case, the assessment data 184 from the second patient health record 180 is excluded from the second patient data set 182. Thus, when the first personal identifier 170 is input and the second patient data set 182 is sent to the first local processing module 110 much as described above, the first local processing module 110 does not receive the second portion of the second patient health record 180 (e.g., the assessment data 184).

Accordingly, the first zone database module 114 and zone database 120 can act as a common repository for portions of a patient's individual health records at multiple health care providers. Thus, the system provides highly portable health data and a number of advantages for patients who may visit two or more health care providers. When visiting a particular health care provider, the system may manually (e.g., at the prompting of a user or patient) or automatically refresh its local health records for the patient to include the latest health data stored at the zone level. Thus a treating physician is provided access to health data describing the patient's past medical history with other health care providers. In some cases the health data received from the zone database module(s) excludes portions of the health records of other providers. After updating local records, a treating physician may be able to consult a number of basic health data (e.g., subjective, objective, plan data) from patient visits to other facilities, while also accessing full health records from previous patient visits at that location (e.g., the physician's prior diagnoses for the patient).

The common health data stored in the zone database may exclude portions of the individual health records (e.g., assessment data), although this is not necessary in all embodiments. For example, in some cases a patient may authorize the sharing of all health data with one or more other health care providers. In this case the local processing modules transmit entire patient health records to the zone database module(s) for eventual relaying to other local processing modules at other locations. Thus, a treating physician may in some cases have access to entire records from other facilities.

In several embodiments herein the local processing modules are often described as associated with a local health care provider, although this is not necessarily the case in all embodiments. In some cases, local processing modules are associated with other facilities and locations that may be thought to be outside the scope of what is traditionally considered a “health care provider” such as hospitals and clinics. For example, local processing modules may be associated and included with emergency vehicles such as ambulances. As a patient is transported to a hospital, emergency personnel may access health data from the first zone database using the patient's personal identifier (e.g., biometric marker). The emergency personnel may also gather health data, such as current condition, known medications, etc., and this health data may be uploaded to the first zone database where it can be accessed by the waiting staff at the hospital.

The local processing modules may be associated with a wide variety of other locations and facilities, including but not limited to hospitals, clinics, ambulances and other emergency vehicles, pharmacies, schools, refugee camps, and/or personal patient computers among other users.

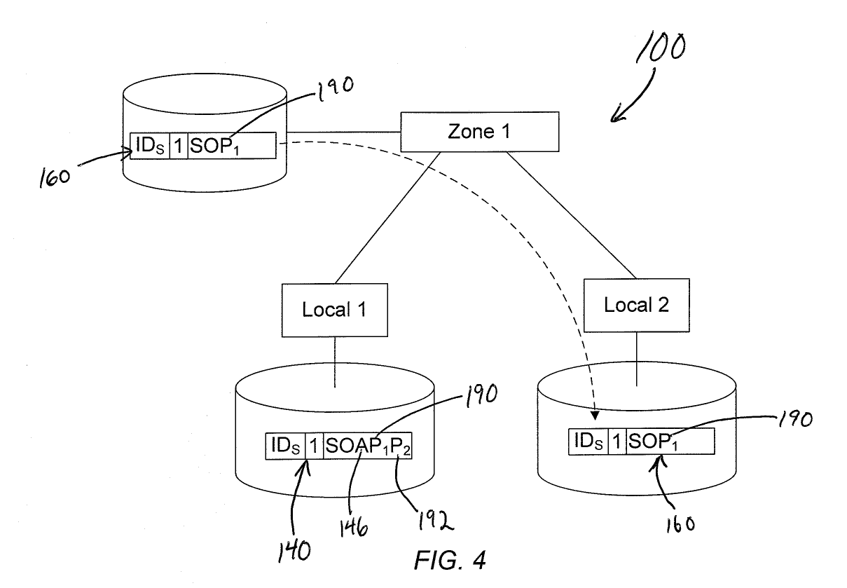

Turning to FIG. 4, in some embodiments the health data stored in patient health records may be further divided in one or more subcategories. For example, patient plan data may be separated into P₁ data 190 including information about patient prescriptions and medications and P₂ data 192 including data about instructions, such as physician-recommended treatments and therapies. In some cases it may be desirable to exclude one or more subcategories of health data. In some embodiments the first portion of the first patient health record 140 excluded from the first patient data set 160 includes P₂ data 192 including treatment and therapy prescriptions. In some cases the first portion excluded from the data set includes both the assessment data 146 and the P₂ data 192.

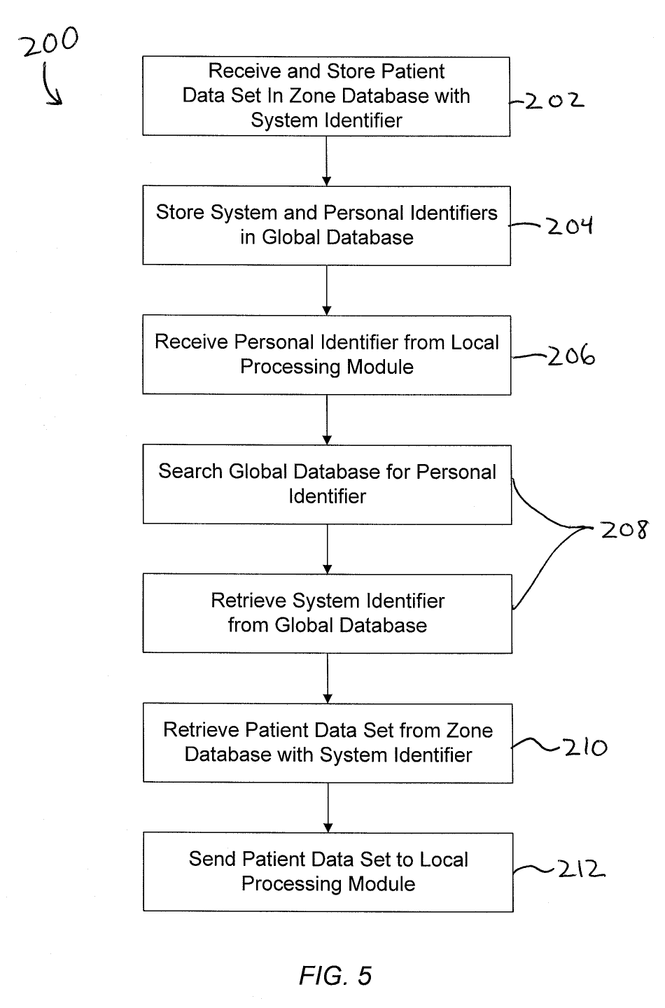

FIG. 5 shows a flow diagram of a method 200 for managing electronic health data according to some embodiments of the invention. The method 200 may be performed by portions or all of the system 100 described above. In some embodiments, the method includes receiving 202 a first patient data set from a first local processing module. As described above, in some cases the first patient data set includes part of an electronic first patient health record stored in a first local database. The first patient health record may correspond to a first patient of a first health care provider. In preferred embodiments, the first patient data set excludes a first portion of the first patient health record. The method 200 may also include storing the first patient data set in a first zone database using a first system identifier and maintaining a global database storing the first system identifier and a corresponding first personal identifier corresponding to the first patient 204.

In some embodiments, the method 200 includes receiving 206 the first personal identifier from a second local processing module and searching 208 the global database for the first personal identifier and retrieving the corresponding first system identifier. After retrieving the first system identifier, the method includes retrieving 210 the first patient data set from the first zone database using the first system identifier, and finally sending 212 the first patient data set to the second local processing module without sending the first portion of the first patient health record stored on the first local database.

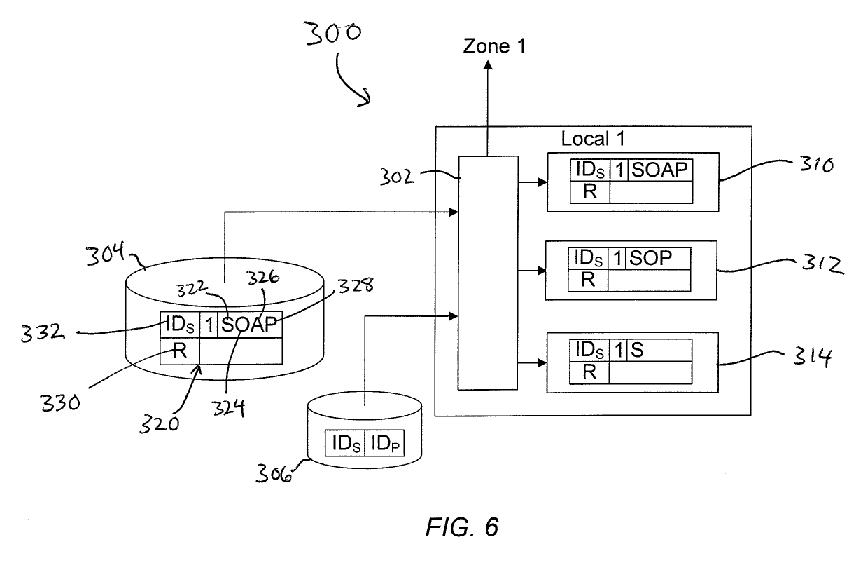

In some embodiments one or more local processing modules can be configured to provide access to patient health data while excluding portions of the health data depending upon a user's authorization level. Turning to FIG. 6, in some embodiments a local processing module 300 includes a database server module 302 that communicates with a local database 304 storing patient health data. The database server module 302 may also interface with a zone database module coupled through the overall system, and synchronize portions of the health data between the local database 304 and a zone database. The local processing module 300 may also communicate with a local identification database 306 that stores personal identifiers and system identifiers corresponding to patients and their electronic health records. In some embodiments, the local processing module 300 may also provide one or more access modules such as a first access module 310, a second access module 312, and a third access module 314. The access modules can provide system users with differing levels of access to patient health data depending upon the users' authorization. For example, each access module can provide a user interface for displaying and entering health data at varying levels. The access modules may comprise remote log-in clients running on multiple computers in a health facility.

In some cases the local processing module 300 is configured to provide users access to a first patient health record 320, which includes a variety of health data, including subjective data 322, objective data 324, assessment data 326 and plan data 328. The health record may also include patient registration information 330, and be stored in the database 304 with a first system identifier 332. In some embodiments the local processing module 300 provides the first access module 310 with full access to the patient health record 320. For example, the first access module 310 can comprise a physician log-in module, which allows a physician to review the entire contents of the patient health record stored in the local database 304.

In some embodiments, the local processing module 300 is adapted to provide the first patient health record to the second access module 312, but excluding a first portion of the first patient health record. For example, the first portion of the health record 320 may comprise the assessment data 326. Thus, a user reviewing the first patient's health record using the second access module 312 may have access to subjective 322, objective 324 and plan data 328 about the first patient, but not have access to assessment data. For example, in some cases the second access module 312 can be a nurse or technician access module.

In some embodiments, the local processing module 300 is adapted to provide the first patient health record to the third access module 314, but excluding the first portion of the first patient health record and excluding an additional second portion of the health record. For example, the second portion of the health record 320 may comprise the objective data 324 and the plan data 328. Thus, a user reviewing the first patient's health record using the third access module 314 may have access to subjective data 322 and registration data 330, but not have access to objective, assessment, and plan data. For example, in some cases the third access module 314 can be a receptionist access module.

Accordingly, the local processing module 300 can be adapted to provide varying levels of access to patient health data as may be required or desired in a multi-user environment. As just one example, in a hospital or clinic setting access to health data can be partitioned depending upon the needs of particular users. Physicians may be provided full access to health data, for example, while receptionist staff may only be provided access to basic patient information such as registration information and notes entered into the system regarding the patient's subjective self-assessments.

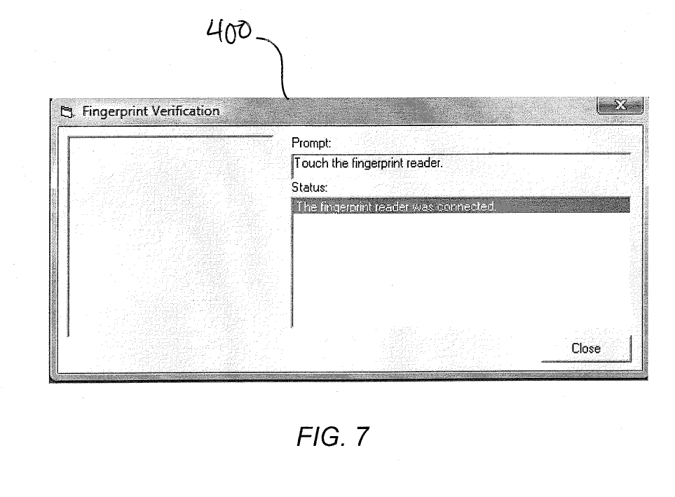

FIGS. 7-10 illustrate multiple user interface screens provided as part of the local access modules of FIG. 6. FIG. 7 is a depiction of a system prompt 400 for biometric data. In some embodiments of the invention biometric data (e.g., fingerprints, retinal scans, and the like) may be used as personal identifiers to identify patients and/or users accessing the stored health data. For example, a patient may provide his or her fingerprint through a biometric scanning device 28 as shown in FIG. 2. A doctor or nurse may also access patient records through use of the biometric scanning device 28.

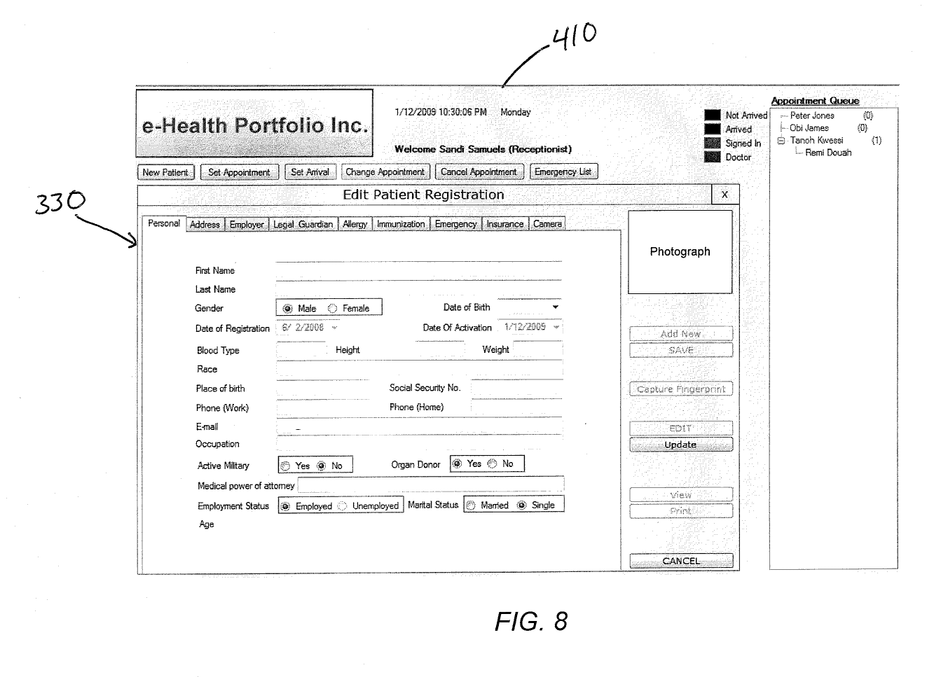

FIG. 8 is a patient registration screen 410 that allows a user to enter registration data 330 for a particular patient. For example, the registration screen 410 may be provided by the third access module 314 of FIG. 6, and allow a receptionist to access registration data 330 but not more sensitive and private objective, assessment, and plan data for a patient.

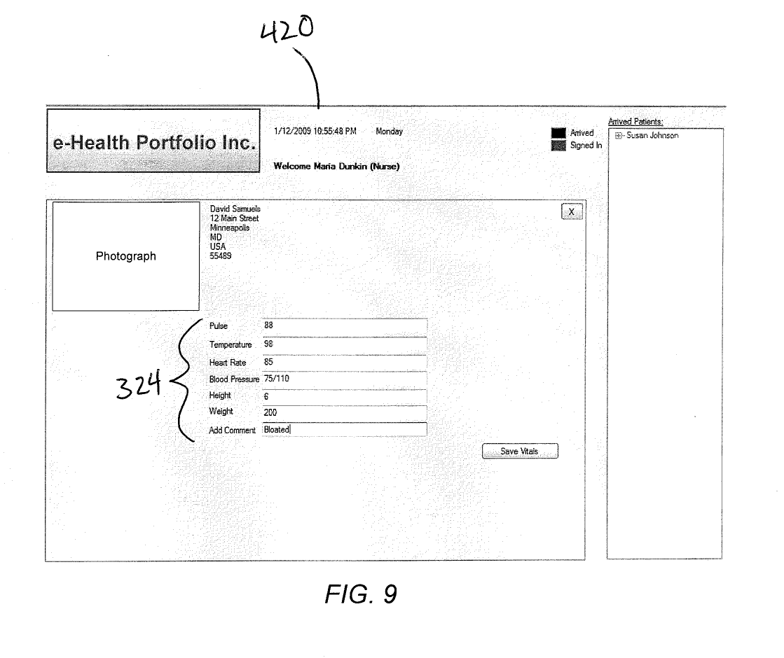

FIG. 9 is a patient vitals input screen 420 that allows a user to enter objective data 324 about a patient. In some embodiments this input screen 420 may be provided by the second access module 312 shown in FIG. 6. The data input screen 420 can, for example, provide a nurse with access to the patient's health record in order to input objective data 324 such as pulse, temperature, heart rate, and so on. The second access module 412 may also provide the nurse with access to subjective data and plan data about the patient, although this is not shown in FIG. 9.

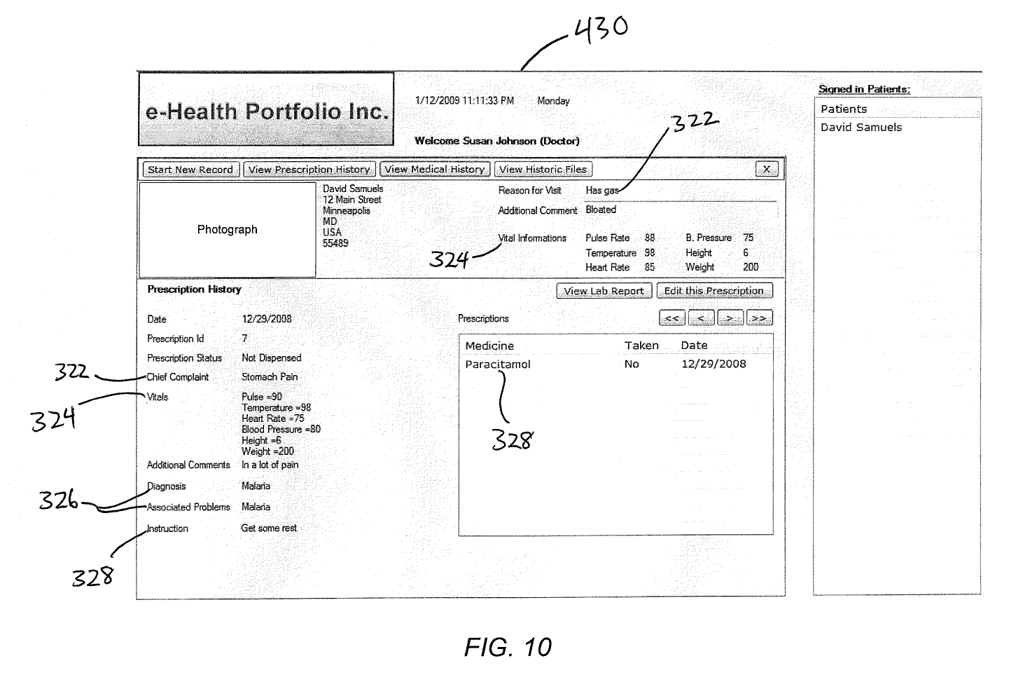

FIG. 10 is a doctor access screen 430 that allows a user to review a variety of health data about a patient. For example, this screen 430 may be provided by the first access module 310 of FIG. 6, and allow a doctor to review and edit the complete medical history of the patient, including subjective data 322, objective data 324, assessment data 326, and plan data 328. Thus in this embodiment a doctor is provided access to the entire patient health record by the first access module 310, while other access modules exclude some portions of the health record from a user's view. This exclusion can help further ensure the privacy and security of the patient's health data by allowing access to the data on a need-to-know basis.

As discussed above, in some embodiments patient health records and data sets may be stored in local and zone databases using a system of personal identifiers and system identifiers. As discussed with reference to FIG. 3A, in some cases a global database module 132 manages and stores personal and system identifiers in a global database 132. In some embodiments, the global database module 132 is adapted to receive a personal identifier from a zone database module 114 and search the global database 132 for the personal identifier and its corresponding system identifier, which it then retrieves and relays back to the zone processing module.

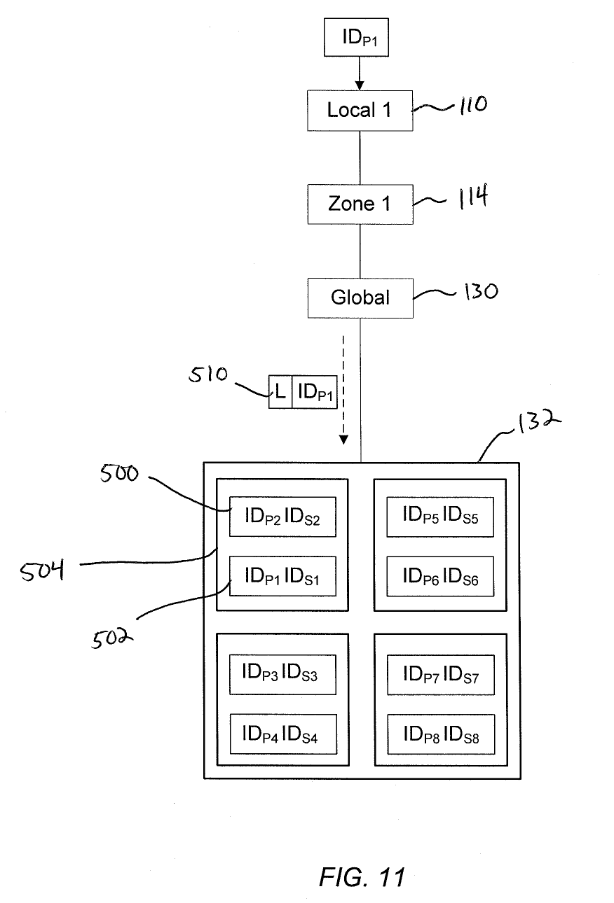

In some embodiments the global database module 130 is adapted to search the global database 132 for a particular personal identifier using location information corresponding to the particular local processing module transmitting the personal identifier to retrieve its corresponding patient health data. FIG. 11 is a block diagram illustrating an organization and searching scheme for the global database module 130 and global database 132 according to some embodiments of the invention. The global database 132 stores multiple personal identifiers and multiple corresponding system identifiers organized into two or more subgroups of data to facilitate searching of the data. In one example, the data may be stored as a first subgroup 500 that includes a second personal identifier ID_{P2} and second system identifier ID_{S2}, a second subgroup 502 that includes a first personal identifier ID_{P1} and first system identifier ID_{S1}, and a third subgroup 504, that includes both the first and the second subgroups 500, 502. The database may include additional subgroups as needed or desired to sort and store additional personal and system identifiers.

In some embodiments the global database module 130 receives location data 510 from the zone database module along with the personal identifier. As shown in FIG. 11, for example, the global database module 130 receives the first personal identifier ID_{P1} along with the location data 510 from the zone database module 114. In certain embodiments the location data 510 corresponds to a location of the local processing module (e.g., the first local processing module 110) sending the personal identifier. For example, the location data 510 may be indicative of a geographical area, an address, a location within a predefined location grid, or any other suitable location indicator. In some cases the location data 510 represents the network location of the first local processing module 110 (i.e., the module sending the data request) and may comprise an Internet Protocol (IP) address of a computing system hosting the first local processing module 110 and/or an IP address of a computing system hosting the first zone database module 114.

After receiving the first personal identifier and the location data 510, the global database module 130 searches the global database 132 for the first personal identifier and its corresponding system identifier using the location data 510. For example, the module may prioritize its searching of the database 132 based on the location data 510. As shown in FIG. 11, for example, the first subgroup 500 may represent a range of IP addresses including the IP address of the first local processing module 110. The second subgroup 502 may represent a range of IP addresses for other local processing modules. Additional subgroups of data may represent additional ranges of IP addresses according to some embodiments.

In one embodiment, the module starts its search of the global database 132 in the smallest subgroup corresponding to the location data 510. For example, because in this example the location data 510 corresponds to the IP address of the first local processing module, the search for the first personal identifier ID_{P1} begins in the first subgroup 500, which corresponds to the range of IP addresses including the IP address of the first local processing module. If the personal identifier is found, its corresponding system identifier is retrieved and relayed back to the zone database module and local processing modules. If the requested personal identifier is not found, in some cases the system searches the next larger subgroup, the third subgroup 504. When searching the third subgroup, the first personal identifier ID_{P1} is found within the second subgroup 502 within the third subgroup. In some cases, the algorithm may include re-searching the first subgroup 500 within the third subgroup 504, although this is not necessary in all embodiments.

Thus the system can prioritize searching for personal identifiers based upon location data, such as the location of the local processing module making the data request. In some cases this organization and method of searching the global database can advantageously prioritize searching based on the most likely location in the database for the desired personal identifier. For example, since the request for data comes from the first local processing module, it may be most likely that the first personal identifier corresponds to a patient that normally attends a health care provider associated with the first local processing module. By searching a subgroup of personal identifiers associated with that health care provider, the first personal identifier may be found more quickly and accurately.

In the case where the data request comes from a local processing module associated with a facility that is not the normal or preferred choice for a patient, the system can search increasingly larger subgroups of personal identifiers. For example, the increasingly larger subgroups may correspond to groups of local processing modules in the same geographic area as the first local processing module, since it may be more likely for a patient to visit a clinic in the same general area as his normal clinic. In another example, when an ambulance picks up a patient, it may be most likely that the patient's identifier will be found in a search of patient identifiers corresponding to the nearest facility hosting a local processing module.

The system can thus prioritize and search for personal identifiers more quickly and accurately in some embodiments. For example, in certain embodiments employing biometric markers (e.g., fingerprints) as personal identifiers, searching a database full of biometric markers can be a time consuming task. By focusing the initial searches on limited subgroups of the biomarkers, a match can hopefully be found more quickly than if the entire database is searched. In addition, limiting searches to smaller subgroups of biomarkers can provide a more accurate and reliable match. For example, in some cases searching hundreds of thousands of biomarkers may result in more than one potential match depending upon the resolution and sophistication of the search. By limiting the number of biomarkers being searched at a time, the likelihood that a potential match is the correct match is increased.

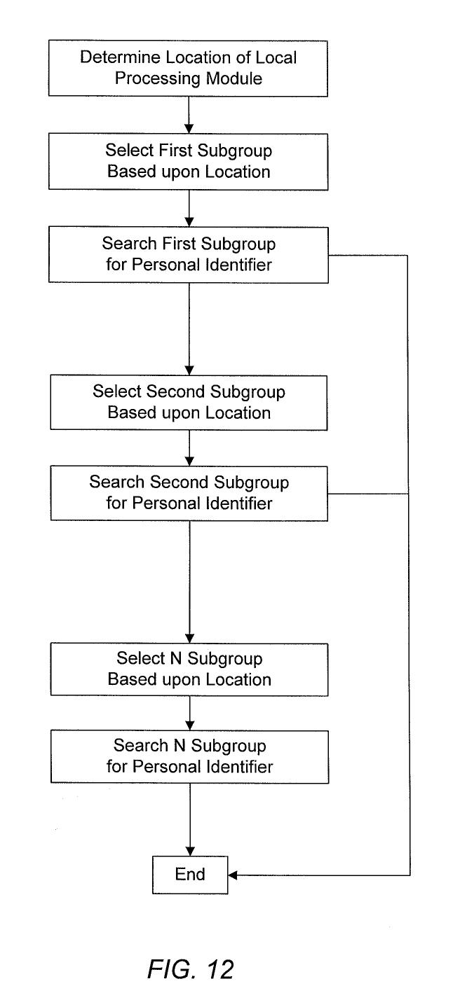

FIG. 12 illustrates steps in a method of searching the global database 132 similar to that described above. For example, the method may include selecting and searching N subgroups until the personal identifier and corresponding system identifier are found and retrieved.

Thus, embodiments of the invention are disclosed. Although the present invention has been described in considerable detail with reference to certain disclosed embodiments, the disclosed embodiments are presented for purposes of illustration and not limitation and other embodiments of the invention are possible. One skilled in the art will appreciate that various changes, adaptations, and modifications may be made without departing from the spirit of the invention and the scope of the appended claims.

What is claimed is:

1. A computerized method for managing electronic health data, comprising:
receiving a first patient data set from a first local processing module, the first patient data set including part of an electronic first patient health record stored in a first local database, the first patient health record corresponding to a first patient of a first health care provider, and the first patient data set excluding a first portion of the first patient health record;
storing the first patient data set in a first zone database using a first system identifier; and
maintaining a global database storing the first system identifier and a corresponding first personal identifier corresponding to the first patient.

2. The method of claim 1, further comprising:
receiving the first personal identifier from a second local processing module;
searching the global database for the first personal identifier and the corresponding first system identifier;
retrieving the first patient data set from the first zone database using the first system identifier; and
sending the first patient data set to the second local processing module without sending the first portion of the first patient health record stored on the first local database.

3. The method of claim 2, wherein the global database stores multiple personal identifiers and multiple corresponding system identifiers, including the first personal identifier and the first system identifier, and wherein searching the global database for the first personal identifier comprises selecting a first subgroup of the multiple personal identifiers based upon a location of the second local processing module and searching the first subgroup for the first personal identifier and the corresponding first system identifier.

4. The method of claim 3, wherein searching the global database for the first personal identifier further comprises selecting a second subgroup of the multiple personal identifiers based upon the location of the second local processing module and searching the second subgroup for the first personal identifier and the corresponding first system identifier.

5. The method of claim 4, wherein selecting the first subgroup is based upon an internet protocol address of a computing system hosting the second local processing module and wherein selecting the second subgroup is based upon an internet protocol address of the first zone database.

6. The method of claim 3, wherein the multiple personal identifiers comprise biometric markers and wherein the first personal identifier comprises a first biometric marker received from the first patient via a biometric scanning device.

7. The method of claim 1, wherein the first patient health record comprises subjective data, objective data, assessment data, and plan data, all corresponding to the first patient, and wherein the first portion of the first patient health record comprises the assessment data.

8. The method of claim 7, wherein the first local processing module comprises first, second, and third access modules, and further comprising providing the first patient health record to the first access module and providing the first patient health record excluding the first portion to the second and third access modules.

9. The method of claim 8, wherein providing the first patient health record to the third access module comprises providing the first patient health record excluding the first portion and excluding a second portion of the first patient health record comprising the objective data.

10. A computerized health data management system, comprising:
a first local processing module adapted to store an electronic first patient health record in a first local database and generate a first patient data set based on the first patient health record, the first patient health record corresponding to a first patient of a first health care provider, and the first patient data set excluding a first portion of the first patient health record;
a first zone database module adapted to receive the first patient data set from the first local processing module and store the first patient data set in a first zone database using a first system identifier corresponding to the first patient; and
a global database module adapted to store the first system identifier and a corresponding first personal identifier in a global database and retrieve the first system identifier using the first personal identifier, wherein the first personal identifier corresponds to the first patient.

11. The system of claim 10, further comprising a second local processing module adapted to receive the first personal identifier and send the first personal identifier to the first zone database module, wherein
the first zone database module is further adapted to receive the first personal identifier from the second local processing module, send the first personal identifier to the global database module, receive the first system identifier from the global database module, retrieve the first patient data set from the first zone database using the first system identifier, and send the first patient data set to the second local processing module without sending the first portion of the first patient health record stored in the first local database.

12. The system of claim 11, wherein the global database stores multiple personal identifiers and multiple corresponding system identifiers, including the first personal identifier and the first system identifier, and wherein the global database module is further adapted to select a first subgroup of the multiple personal identifiers based upon a location of the second local processing module and search the first subgroup for the first personal identifier and the corresponding first system identifier.

13. The system of claim 12, wherein the global database module is further adapted to select a second subgroup of the multiple personal identifiers based upon the location and search the second subgroup for the first personal identifier and the corresponding first system identifier.

14. The system of claim 13, wherein selecting the first subgroup is based upon an internet protocol address of a computing system hosting the second local processing module and wherein selecting the second subgroup is based upon an internet protocol address of the first zone database.

15. The system of claim 12, wherein the multiple personal identifiers comprise biometric markers and wherein the first personal identifier comprises a first biometric marker received from the first patient via a biometric scanning device.

16. The system of claim 10, wherein the first patient health record comprises subjective data, objective data, assessment data, and plan data, and wherein the first portion of the first patient health record comprises the assessment data.

17. The system of claim 16, wherein the plan data comprises instruction data and prescription data, and wherein the first portion of the first patient health record further comprises the instruction data.

18. The system of claim 16, wherein the first local processing module comprises first, second, and third access modules, and wherein the first local processing module is further adapted to provide the first patient health record to the first access module and the first patient health record excluding the first portion to the second and third access modules.

19. A computer-readable storage medium having computer-executable instructions for performing a method for managing electronic medical records, the method comprising:
receiving a first patient data set from a first local processing module, the first patient data set including part of an electronic first patient health record stored in a first local database, the first patient health record corresponding to a first patient of a first health care provider, and the first patient data set excluding a first portion of the first patient health record;
storing the first patient data set in a first zone database using a first system identifier;
receiving a first personal identifier corresponding to the first patient from a second local processing module;
retrieving the first system identifier from a global database using the first personal identifier, the global database storing the first system identifier and first personal identifier;
retrieving the first patient data set from the first zone database using the first system identifier; and
sending the first patient data set to the second local processing module without sending the first portion of the first patient health record stored in the first local database.

20. The computer-readable storage medium of claim 19, wherein the first patient health record comprises subjective data, objective data, assessment data, and plan data, and wherein the first portion of the first patient health record comprises the assessment data.
